(19) United States
(12) Patent Application Publication
(10) Pub. No.: US 2026/0081080 A1
(43) Pub. Date: Mar. 19, 2026

(54) MULTILAYER CERAMIC CAPACITOR

(71) Applicant: Murata Manufacturing Co., Ltd., Nagaokakyo-shi (JP)

(72) Inventors: Shota TATEISHI, Nagaokakyo-shi (JP); Daisuke FUKUDA, Nagaokakyo-shi (JP); Satoshi FUKUDA, Nagaokakyo-shi (JP)

(21) Appl. No.: 19/027,297

(22) Filed: Jan. 17, 2025

(30) Foreign Application Priority Data
Sep. 19, 2024 (JP) 2024-162045

(51) Int. Cl. H01G 4/30; H01G 4/012; H01G 4/12; H01G 4/232

(52) U.S. Cl. CPC H01G 4/30; H01G 4/012; H01G 4/2325; H01G 4/1236

(57) ABSTRACT

A multilayer ceramic capacitor includes first and second internal electrode layers, and an intermediate electrode layer, a first floating island electrode in a region between an end surface and the intermediate electrode layer of the multilayer body, and a second floating island electrode in a region between a lateral surface and an internal electrode layer of the multilayer body, in a dielectric region including a dielectric layer interposed between the first internal electrode layers or the second internal electrode layers in the lamination direction.

### CROSS REFERENCE TO RELATED APPLICATIONS

This application is based on and claims the benefit of priority from Japanese Patent Application No. 2024-162045, filed on Sep. 19, 2024, the entire contents of which are incorporated herein by reference.

### BACKGROUND OF THE INVENTION

### 1. Field of the Invention

The present invention relates to multilayer ceramic capacitors.

### 2. Description of the Related Art

Conventionally, multilayer ceramic capacitors designed to withstand high voltage, known as series-structured multilayer ceramic capacitors, have been recognized, in which a plurality of capacitor portions are serially connected (refer to Japanese Unexamined Patent Application Publication No. 2012-209495).

Series-structured multilayer ceramic capacitors which form the series-connected capacitance tend to improve voltage resistance at the cost of reduced capacitance. In order to address this, measures such as increasing the number of stacked internal electrode layers and dielectric layers have been used to maintain capacitance.

However, increasing the number of stacked internal electrode layers and dielectric layers leads to increased intrinsic stress caused by the difference in shrinkage between the dielectric layers and internal electrode layers, which may result in delamination at the interface between the internal electrode layers and dielectric layers.

### SUMMARY OF THE INVENTION

Example embodiments of the present invention provide series-structured multilayer ceramic capacitors each able to reduce or prevent delamination between the internal electrode layers and the dielectric layers.

The inventors of example embodiments of the present invention have discovered that delamination at the interface between the internal electrode layers and the dielectric layers can be reduced or prevented by placing electrodes at specific locations in the multilayer body that defines the multilayer ceramic capacitor.

Specifically, an example embodiment of the present invention provides a multilayer ceramic capacitor including a multilayer body that includes stacked dielectric layers, stacked internal electrode layers, two main surfaces on opposite sides in a lamination direction, two lateral surfaces on opposite sides in a width direction orthogonal or substantially orthogonal to the lamination direction, and two end surfaces including a first end surface and a second end surface on opposite sides in a length direction orthogonal or substantially orthogonal to both the lamination direction and the width direction, a first external electrode on the first end surface, and a second external electrode on the second end surface. The internal electrode layers include a first internal electrode layer, a second internal electrode layer, and an intermediate electrode layer. The first internal electrode layer includes a first extension portion including one end extending to the first end surface and connected to the first external electrode, and a first counter portion connected to the first extension portion and facing an internal electrode layer adjacent in the lamination direction. The second internal electrode layer includes a second extension portion including one end extending to the second end surface and connected to the second external electrode, and a second counter portion connected to the second extension portion and facing an internal electrode layer adjacent in the lamination direction. The intermediate electrode layer, not connected to either the first external electrode or the second external electrode, is an internal electrode layer that defines a serially connected capacitor together with the first internal electrode layer and the second internal electrode layer. The multilayer ceramic capacitor includes a first floating island electrode in a region between the end surfaces and the intermediate electrode layer of the multilayer body, and a second floating island electrode in a region between the lateral surfaces and the internal electrode layers of the multilayer body, in a dielectric region including the dielectric layers interposed between the first internal electrode layers or the second internal electrode layers in the lamination direction.

According to example embodiments of the present invention, in a series-structured multilayer ceramic capacitor, intrinsic stress caused by a difference in shrinkage between the dielectric layers and the internal electrodes is able to be reduced, and delamination at the interface between the dielectric layers and the internal electrodes is able to be reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a two-portion-structured multilayer ceramic capacitor according to a first example embodiment of the present invention.

FIG. 2 is a cross-sectional view along the line II-II in FIG. 1, illustrating a schematic structure of the two-portion-structured multilayer body of the first example embodiment of the present invention.

FIG. 3 is a cross-sectional view along the line III-III in FIG. 2.

FIG. 4A is a cross-sectional view along the line IVA-IVA in FIG. 2, illustrating a cross section along a first internal electrode layer and a second internal electrode layer.

FIG. 4B is a cross-sectional view along the line IVB-IVB in FIG. 2, illustrating a cross section along the intermediate electrode layer.

FIG. 5 is a diagram illustrating a schematic configuration of a three-portion-structured multilayer body according to a second example embodiment of the present invention, corresponding to FIG. 2 of the first example embodiment of the present invention.

FIG. 6 is a diagram illustrating a schematic configuration of a four-portion-structured multilayer body according to a third example embodiment of the present invention, corresponding to FIG. 2 of the first example embodiment of the present invention.

### DETAILED DESCRIPTION OF THE EXAMPLE EMBODIMENTS

Hereinafter, example embodiments of the multilayer ceramic capacitor of the present invention will be described with reference to the drawings. However, the present invention is not limited to the example embodiments.

### First Example Embodiment

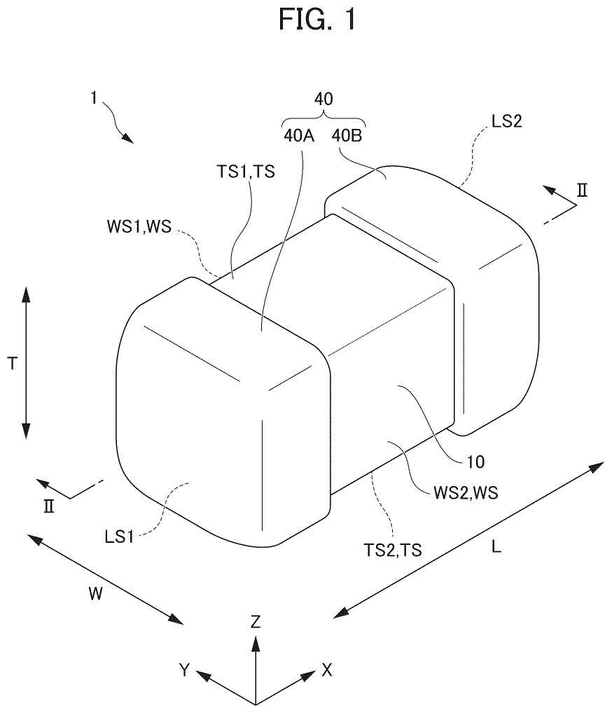

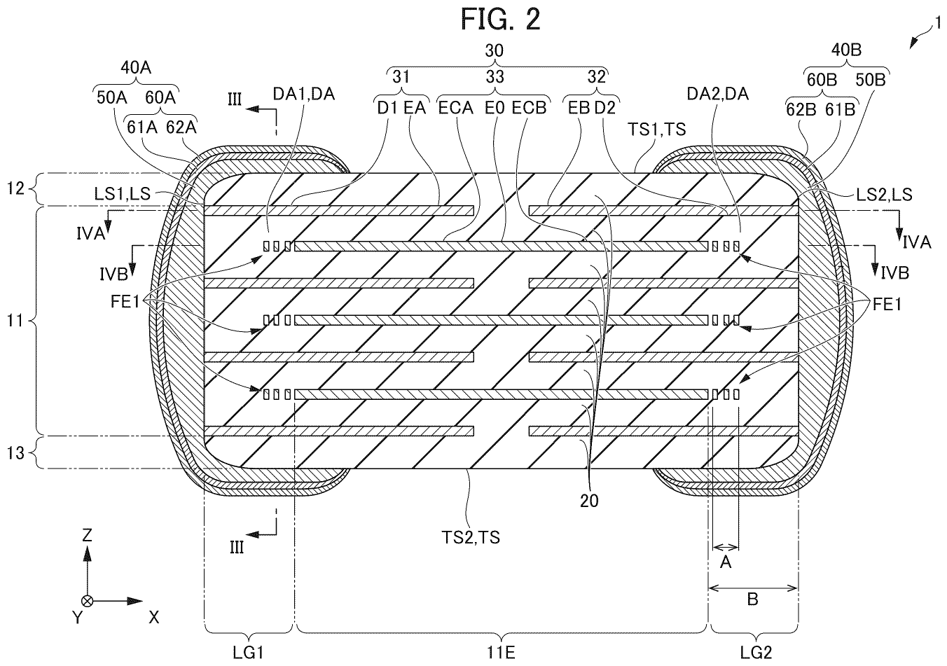

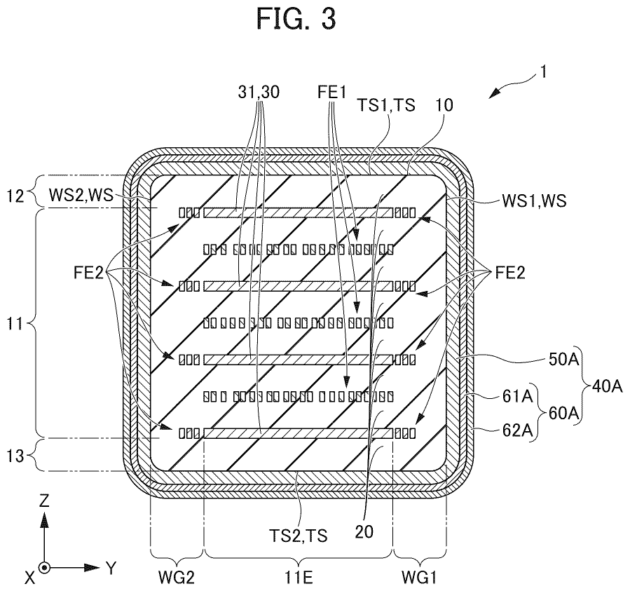

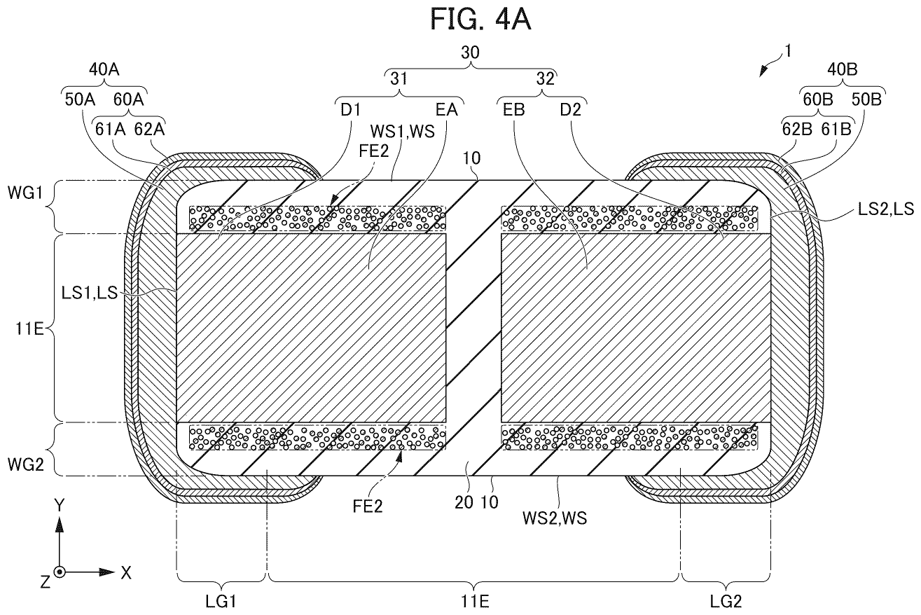

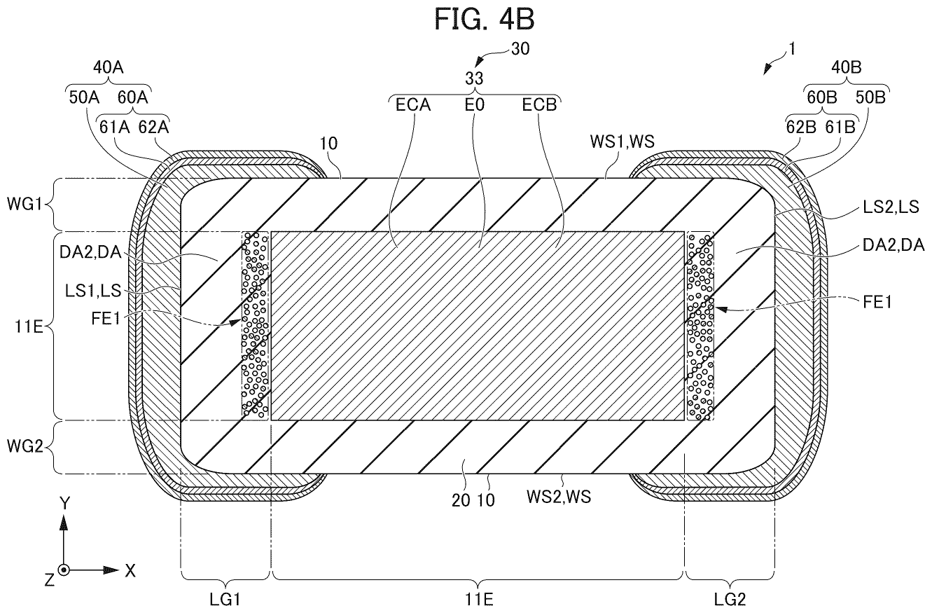

A multilayer ceramic capacitor 1 as a two-portion-structured multilayer ceramic electronic component according to a first example embodiment of the present invention will be described with reference to the drawings. The multilayer ceramic capacitor 1 of the present example embodiment is a temperature-compensating capacitor with a small rate of capacitance change due to temperature variations, and is used for filters and high-frequency circuit matching. However, the multilayer ceramic capacitor 1 of the present example embodiment is not limited to such applications. FIG. 1 is an external perspective view of the two-portion-structured multilayer ceramic capacitor 1 according to the first example embodiment. FIG. 2 is a cross-sectional view along the line II-II in FIG. 1, illustrating the schematic structure of the two-portion-structured multilayer body of the first example embodiment. FIG. 3 is a cross-sectional view along the line III-III in FIG. 2. FIG. 4A is a cross-sectional view along the line IVA-IVA in FIG. 2, illustrating the cross section along the first internal electrode layer and the second internal electrode layer. FIG. 4B is a cross-sectional view along the line IVB-IVB in FIG. 2, illustrating the cross section along the intermediate electrode layer.

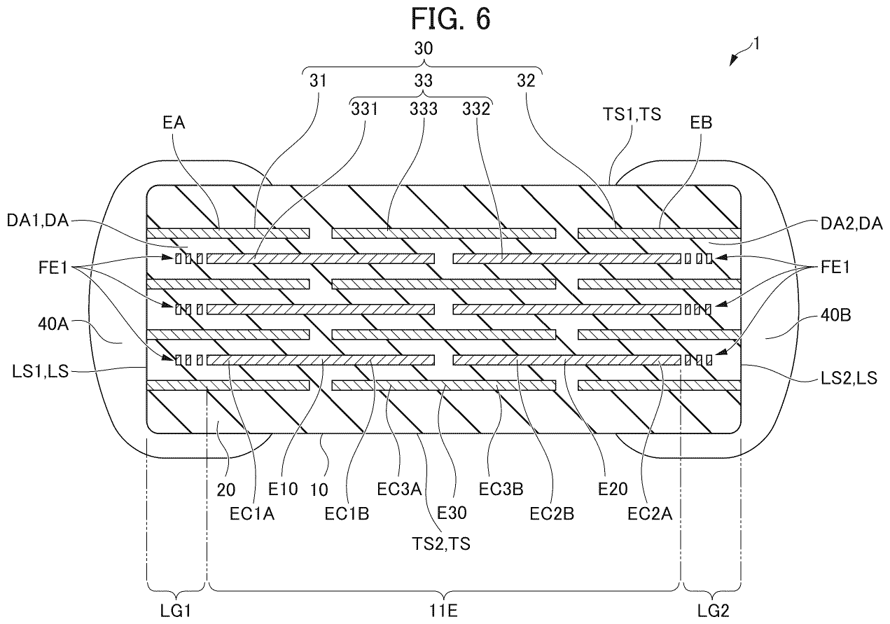

The drawings are schematically simplified for the purpose of illustrating the content of the present invention, and the proportions of the illustrated components or the ratios of dimensions between components may not match those described in the specification. Also, components described in the specification may be omitted in the drawings, or their numbers may be omitted for simplicity. For example, the number of the internal electrode layers illustrated in FIGS. 2 and 3 is seven for the sake of explanation, but this does not indicate the actual number of the internal electrode layers 30. The same applies to FIG. 6. Terms used in the present specification to specify shapes, geometrical conditions, and the extent thereof, such as “parallel”, “orthogonal”, “identical”, and values of lengths and angles, are intended to be interpreted inclusively within a range that could achieve similar functionality, not limited to their strict meanings.

As illustrated in FIG. 1, the shape of the multilayer ceramic capacitor 1 according to an example embodiment is rectangular or substantially rectangular parallelepiped. The multilayer ceramic capacitor 1 includes a rectangular or substantially rectangular parallelepiped multilayer body 10 and a pair of external electrodes 40 spaced apart from each other at both ends of the multilayer body 10.

In FIG. 1, the arrow T indicates the lamination direction of the multilayer ceramic capacitor 1 and the multilayer body 10. The lamination direction T also represents the thickness direction and the height direction of the multilayer ceramic capacitor 1 and the multilayer body 10. In FIG. 1, the arrow L indicates the length direction of the multilayer ceramic capacitor 1 and the multilayer body 10, in which the length direction is orthogonal or substantially orthogonal to the lamination direction T. In FIG. 1, the arrow W indicates the width direction of the multilayer ceramic capacitor 1 and the multilayer body 10, in which the width direction is orthogonal or substantially orthogonal to both the lamination direction T and the length direction L. The pair of external electrodes 40 are provided at both ends of the multilayer body 10 in the length direction L.

FIGS. 1 to 4B illustrate an XYZ orthogonal coordinate system. The length direction L of the multilayer ceramic capacitor 1 and the multilayer body 10 corresponds to the X direction. The width direction W of the multilayer ceramic capacitor 1 and the multilayer body 10 corresponds to the Y direction. The lamination direction T of the multilayer ceramic capacitor 1 and the multilayer body 10 corresponds to the Z direction. The cross section illustrated in FIG. 2 is also referred to as an LT cross section. The cross section illustrated in FIG. 3 is also referred to as a WT cross section. The cross section illustrated in FIGS. 4A and 4B is also referred to as an LW cross section.

As illustrated in FIGS. 1 to 4B, the multilayer body 10 includes a first main surface TS1 and a second main surface TS2 on opposite sides in the lamination direction T, a first end surface LS1 and a second end surface LS2 on opposite sides in the length direction L orthogonal or substantially orthogonal to the lamination direction T, and a first lateral surface WS1 and a second lateral surface WS2 on opposite sides in the width direction W orthogonal or substantially orthogonal to both the lamination direction T and the length direction L. Hereinafter, unless necessary to distinguish in particular, the first main surface TS1 and the second main surface TS2 are collectively referred to as the main surface TS, the first end surface LS1 and the second end surface LS2 are collectively referred to as the end surface LS, and the first lateral surface WS1 and the second lateral surface WS2 are collectively referred to as the lateral surface WS.

As illustrated in FIG. 1, the shape of the multilayer body 10 is rectangular or substantially rectangular parallelepiped. The dimension in the length direction L of the multilayer body 10 is not necessarily longer than the dimension in the width direction W. The corners and edges of the multilayer body 10 are preferably rounded. The corners are where three faces of the multilayer body intersect, and the edges are where two faces of the multilayer body intersect. The surfaces of the multilayer body 10 may include irregularities in whole or in part.

The dimensions of the multilayer body 10 are not particularly limited. However, the dimension of the multilayer body 10 in the length direction L, denoted as the L dimension, is, for example, preferably between about 0.2 mm and about 10 mm inclusive. The dimension of the multilayer body 10 in the lamination direction T, denoted as the T dimension, is, for example, preferably between about 0.1 mm and about 10 mm inclusive. The dimension of the multilayer body 10 in the width direction W, denoted as the W dimension, is, for example, preferably between about 0.1 mm and about 10 mm inclusive.

As illustrated in FIGS. 2 and 3, the multilayer body 10 includes an inner layer portion 11, and first and second main surface-side outer layer portions 12 and 13 interposing the inner layer portion 11 in the lamination direction T.

The inner layer portion 11 includes a plurality of dielectric layers 20 and a plurality of internal electrode layers 30, both of which are stacked alternately in the lamination direction T. The inner layer portion 11 includes the internal electrode layers 30, including an internal electrode layer 30 closest to the first main surface TS1 to an internal electrode layer 30 closest to the second main surface TS2, in the lamination direction T. In the inner layer portion 11, the plurality of internal electrode layers 30 face each other interposing the dielectric layers 20. The inner layer portion 11 defines and functions to generate capacitance, and essentially operates as a capacitor.

The plurality of dielectric layers 20 are made of dielectric materials. The multilayer ceramic capacitor 1 of the present example embodiment, being a temperature-compensating capacitor, utilizes dielectric materials such as, for example, those from the CaZro₃ series (which may hereinafter be abbreviated as CZ series) or (Ca, Sr, Ba) (Zr, Ti)O₃-based dielectric material (which may hereinafter be abbreviated as CSZ series). Dielectric materials from the CZ and CSZ series include, for example, perovskite-type compounds including at least Ca and Zr.

The dielectric materials include, for example, at least one of Ca (Calcium), Zr (Zirconium), or Ti (Titanium). For example, the dielectric layer 20 may include perovskite-type compounds that include Ca and Zr, and optionally Sr and Ti. Specifically, for example, the dielectric layer 20 includes calcium zirconate (CaZro₃), calcium titanate (CaTio₃), strontium titanate (SrTiO₃), barium zirconate (BaZrO₃, a proton-conductive metal oxide), or titanium oxide (TiO₂), among others. Typically, the multilayer ceramic capacitor 1 is fired in a reducing atmosphere, leading to the formation of oxygen vacancies. However, for example, especially, CaZro₃ can reduce or prevent the generation of oxygen vacancies due to its high band gap. As a result, high reliability can be achieved. The dielectric material may also include secondary components such as, for example, Mn, Fe, Cr, Co, Ni compounds added to these main components.

The dielectric layers 20 of the present example embodiment use, for example, materials including at least one of Ca (Calcium), Zr (Zirconium), or Ti (Titanium), and thus have a relative permittivity of, for example, about 20 to about 300, which results in smaller capacitance compared to high permittivity systems. In the dielectric layers 14 of the present example embodiment, the relative permittivity changing almost linearly with temperature, resulting in excellent heat resistance and high-frequency characteristics. The dielectric layers 14 in the present example embodiment negligibly change in capacitance value over time, and exhibit low capacitor loss and excellent stability even under high temperature, high power, and high frequency conditions. The dielectric layers 20 exhibit minimal change in permittivity over time and under applied voltage. The dielectric material is not limited to these examples. For example, high permittivity ceramics such as BaTio₃ series (BT series) may also be used.

The thickness of the dielectric layers 20 is, for example, preferably between about 0.2 μm and about 10 μm inclusive. In particular, the thickness of the dielectric layers 20 is, for example, preferably about 3 μm and about 10 μm inclusive. The number of dielectric layers 20 to be stacked (laminated) is, for example, preferably between 15 and 1200 inclusive. The number of dielectric layers 20 is the total of the number of dielectric layers 20 in the inner layer portion 11, and the number of the dielectric layers 20 in the first main surface-side outer layer portion 12 and the second main surface-side outer layer portion 13.

The plurality of internal electrode layers 30 include a plurality of first internal electrode layers 31, a plurality of second internal electrode layers 32, and an intermediate electrode layer 33. The first internal electrode layers 31 and the second internal electrode layers 32 are adjacently spaced apart in the length direction L. The first and second internal electrode layers 31 and 32 and the intermediate electrode layer 33 are alternately provided in the lamination direction T interposing the dielectric layers 20 therebetween.

The first internal electrode layers 31 extend to the first end surface LS1, and are connected to a first external electrode 40A (to be described later). The second internal electrode layers 32 extend to the second end surface LS2, and are connected to a second external electrode 40B (to be described later). The intermediate electrode layer 33 does not extend to either the first end surface LS1 or the second end surface LS2, and is not connected to either the first external electrode 40A or the second external electrode 40B. The serially connected capacitors are defined by the first internal electrode layers 31, the intermediate electrode layer 33, and the second internal electrode layers 32, which are included in the plurality of internal electrode layers 30. Hereinafter, unless necessary to distinguish, the first internal electrode layers 31, the second internal electrode layers 32, and the intermediate electrode layer 33 may collectively be referred to as the internal electrode layers 30.

As illustrated in FIGS. 2 and 4A, the first internal electrode layer 31 includes a first counter portion EA and a first extension portion D1. The first counter portion EA faces the intermediate electrode layer 33 adjacent in the lamination direction T, interposing the dielectric layer 20 therebetween, provided inside the multilayer body 10. The first internal electrode layer 31 is connected to the first extension portion D1, and includes a first counter portion EA facing another internal electrode layer 30 adjacent in the lamination direction T. The first extension portion D1 extends from the first counter portion EA to the first end surface LS1, and is exposed at the first end surface LS1. The first internal electrode layer 31 includes the first extension portion D1, one end of which extends to the first end surface LS1 and is connected to the first external electrode 40A.

As illustrated in FIGS. 2 and 4A, the second internal electrode layer 32 includes a second counter portion EB and a second extension portion D2. The second counter portion EB faces the intermediate electrode layer 33 adjacent in the lamination direction T, interposing the dielectric layer 20 therebetween, provided inside the multilayer body 10. The second internal electrode layer 32 is connected to the second extension portion D2, and includes the second counter portion EB facing another internal electrode layer 30 adjacent in the lamination direction T. The second extension portion D2 extends from the second counter portion EB to the second end surface LS2, and is exposed at the second end surface LS2. The second internal electrode layer 32 includes the second extension portion D2, one end of which extends to the second end surface LS2 and is connected to the second external electrode 40B.

As illustrated in FIGS. 2 and 4B, the intermediate electrode layer 33 includes a first electrode layer-side counter portion ECA, a second electrode layer-side counter portion ECB, and a coupling portion E0. The first electrode layer-side counter portion ECA faces the first internal electrode layer 31 adjacent in the lamination direction T, interposing a dielectric layer 20 therebetween, provided inside the multilayer body 10. The second electrode layer-side counter portion ECB faces the second internal electrode layer 32 adjacent in the lamination direction T, interposing the dielectric layer 20 therebetween, provided inside the multilayer body 10. The coupling portion E0 couples the first electrode layer-side counter portion ECA with the second electrode layer-side counter portion ECB, and is provided between the first electrode layer-side counter portion ECA and the second electrode layer-side counter portion ECB.

In the multilayer ceramic capacitor 1 according to the present example embodiment, the end portion on the first end surface LS1 side of the intermediate electrode layer 33 is spaced apart from the first end surface LS1. In the multilayer ceramic capacitor 1 according to the present example embodiment, the end portion on the first end surface LS1 side of the intermediate electrode layer 33 is provided farther on the first end surface LS1 side than the end portion 40AE of the first external electrode 40A. However, this arrangement is not limiting. The end portion on the first end surface LS1 side of the intermediate electrode layer 33 may also be provided farther on the second end surface LS2 side than the end portion 40AE of the first external electrode 40A.

The end portion on the second end surface LS2 side of the intermediate electrode layer 33 is spaced apart from the second end surface LS2. In the multilayer ceramic capacitor 1 according to the present example embodiment, the end portion on the second end surface LS2 side of the intermediate electrode layer 33 is provided farther on the second end surface LS2 side than the end portion 40BE of the second external electrode 40B. However, this arrangement is not limiting. The end portion on the second end surface LS2 side of the intermediate electrode layer 33 may also be provided farther on the first end surface LS1 side than the end portion 40BE of the second external electrode 40B.

As illustrated in FIG. 2, in the multilayer ceramic capacitor 1 according to the first example embodiment, the first internal electrode layer 31 and the second internal electrode layer 32 are provided adjacent in the length direction L. In the multilayer ceramic capacitor 1 according to the first example embodiment, the first internal electrode layers 31 and the second internal electrode layers 32 are stacked alternately to overlap the intermediate electrode layer 33, interposing the dielectric layers 20 therebetween.

In the present example embodiment, the first counter portion EA and the first electrode layer-side counter portion ECA face each other, interposing the dielectric layer 20 therebetween, so as to generate the capacitance CAP1 (first capacitor portion CAP1). The second counter portion EB and the second electrode layer-side counter portion ECB of the intermediate electrode layer 33, which includes the first electrode layer-side counter portion ECA, facing each other, interposing the dielectric layer 20 therebetween, so as to generate the capacitance CAP2 (second capacitor portion CAP2). The coupling portion E0 serially connects the capacitance CAP1 and the capacitance CAP2. The multilayer ceramic capacitor 1 of the present example embodiment is a two-portion-structured series-structured multilayer ceramic capacitor 1, in which two capacitor portions are serially connected.

The shapes of the first counter portion EA, the second counter portion EB, the first electrode layer-side counter portion ECA, and the second electrode layer-side counter portion ECB are not particularly limited but are preferably rectangular or substantially rectangular. However, the corners of the rectangular shape may be rounded or provided diagonally. The shapes of the first extension portion D1 and the second extension portion D2 are not particularly limited but are preferably rectangular or substantially rectangular. Again, the corners of the rectangular shape may be rounded or provided diagonally. The shape of the coupling portion E0 is not particularly limited but is preferably rectangular or substantially rectangular.

The dimensions of the first counter portion EA and the first extension portion D1 in the width direction W may be the same or substantially the same, or one of the dimensions may be smaller. The dimensions of the second counter portion EB and the second extension portion D2 in the width direction W may be the same, or one of the dimensions may be smaller. The dimensions of the first and second electrode layer-side counter portions ECA and ECB and the coupling portion E0 in the width direction W may be the same or substantially the same, or one of the dimensions may be smaller.

The first internal electrode layer 31, the second internal electrode layer 32, and the intermediate electrode layer 33 may be made of suitable conductive materials such as, for example, metals including Ni, Cu, Ag, Pd, Au, or alloys including at least one of these metals. When alloys are used, the first internal electrode layer 31, the second internal electrode layer 32, and the intermediate electrode layer 33 may be made of, for example, an Ag—Pd alloy.

The thickness of the first internal electrode layer 31, the second internal electrode layer 32, and the intermediate electrode layer 33 is, for example, preferably between about 0.2 μm and about 2.0 μm inclusive. The total number of the first internal electrode layer 31, the second internal electrode layer 32, and the intermediate electrode layer 33 combined is, for example, preferably between 15 and 1000 inclusive.

As illustrated in FIGS. 2 and 3, the first main surface-side outer layer portion 12 is provided on the first main surface TS1 side of the multilayer body 10. The first main surface-side outer layer portion 12 is a collective portion including the plurality of dielectric layers 20 between the first main surface TS1 and the internal electrode layer 30 closest to the first main surface TS1. On the other hand, the second main surface-side outer layer portion 13 is provided to the second main surface TS2 side of the multilayer body 10. The second main surface-side outer layer portion 13 is a collective portion including the plurality of dielectric layers 20 between the second main surface TS2 and the internal electrode layer 30 closest to the second main surface TS2. The dielectric layers 20 used for the first main surface-side outer layer portion 12 and the second main surface-side outer layer portion 13 may be the same as the dielectric layers 20 used for the inner layer portion 11.

The multilayer body 10 includes a series capacitor forming portion 11E. The series capacitor forming portion 11E includes a portion where the first counter portion EA of the first internal electrode layer 31 faces the first electrode layer-side counter portion ECA of the intermediate electrode layer 33 (portion generating the capacitance CAP1), a portion where the second counter portion EB of the second internal electrode layer 32 faces the second electrode layer-side counter portion ECB of the intermediate electrode layer 33 (portion generating the capacitance CAP2), and a portion serially connecting the capacitance CAP1 with the capacitance CAP2. The series capacitor forming portion 11E is a portion of the inner layer portion 11. FIGS. 4A and 4B illustrate the range of the series capacitor forming portion 11E in the width direction W and the length direction L. The portions of the series capacitor forming portion 11E, which generate the capacitance CAP1 (first capacitor portion CAP1) and capacitance CAP2 (second capacitor portion CAP2), are also referred to as the capacitor active portions.

The multilayer body 10 includes lateral surface-side outer layer portions. The lateral surface-side outer layer portions include a first lateral surface-side outer layer portion WG1 and a second lateral surface-side outer layer portion WG2. The first lateral surface-side outer layer portion WG1 is a portion including the dielectric layers 20 between the series capacitor forming portion 11E and the first lateral surface WS1. The second lateral surface-side outer layer portion WG2 is a portion including the dielectric layers 20 between the series capacitor forming portion 11E and the second lateral surface WS2. FIGS. 3, 4A, and 4B illustrate the range of the first lateral surface-side outer layer portion WG1 and the second lateral surface-side outer layer portion WG2 in the width direction W. These lateral surface-side outer layer portions are also referred to as W gaps or side gaps. The multilayer body 10 includes end surface-side outer layer portions. The end surface-side outer layer portions include a first end surface-side outer layer portion LG1 and a second end surface-side outer layer portion LG2. The first end surface-side outer layer portion LG1 is a portion including the dielectric layers 20 and the first extension portion D1, provided between the series capacitor forming portion 11E and the first end surface LS1. In other words, the first end surface-side outer layer portion LG1 is a collective portion including a portion of the plurality of dielectric layers 20 on the first end surface LS1 side and the plurality of first extension portions D1. The second end surface-side outer layer portion LG2 is a portion including the dielectric layers 20 and the second extension portion D2, provided between the series capacitor forming portion 11E and the second end surface LS2. In other words, the second end surface-side outer layer portion LG2 is a collective portion including a portion of the plurality of dielectric layers 20 on the second end surface LS2 side and the plurality of second extension portions D2. FIGS. 2, 4A, and 4B illustrate the range of the first end surface-side outer layer portion LG1 and the second end surface-side outer layer portion LG2 in the length direction L. The end surface-side outer layer portions are also referred to as L-gaps or end gaps. The series capacitor forming portion 11E of the multilayer body 10 includes a series connection region. The series connection region is a portion including the dielectric layer 20 and the coupling portion E0, which are provided between the portion generating the capacitance CAP1 and the portion generating the capacitance CAP2. In other words, the series connection region is a collective portion including the central portion of the plurality of dielectric layers 20 in the length direction L, and the plurality of coupling portions E0. The series connection region is also referred to as a middle gap.

As illustrated in FIGS. 2, 3, and 4B, the multilayer ceramic capacitor 1 includes a first floating island electrode FE1 in the region between the end surface LS and the intermediate electrode layer 33 of the multilayer body 10, in the dielectric region DA formed with the dielectric layer 20 interposed between the first internal electrode layers 31 or the second internal electrode layers 32 in the lamination direction T. Here, the region between the end surface LS of the multilayer body 10 and the intermediate electrode layer 33 refers to a range in which the first floating electrode FE1 is not in contact with either the end surface LS of the multilayer body 10 or the intermediate electrode layer 33. The multilayer ceramic capacitor 1 includes the first floating island electrode FE1 that is not connected to either the first external electrode 40A or the second external electrode 40B, in the region between the first end surfaces LS1 and the intermediate electrode layer 33, in the first dielectric region DA1 including the dielectric layer 20 interposed between the first internal electrode layers 31 in the lamination direction T inside the first end surface-side outer layer portion LG1, also in the region between the second end surfaces LS2 and the intermediate electrode layer 33, in the second dielectric region DA2 including the dielectric layer 20 interposed between the second internal electrode layers 32 in the lamination direction T inside the second end surface-side outer layer portion LG2. The first floating island electrode FE1 includes a plurality of small scattered electrode pieces (metal pieces), which can also be seen as a discontinuous group of electrodes when one of the LT, WT, and LW cross sections of the multilayer ceramic capacitor 1 is observed using a scanning electron microscope or metallurgical microscope.

The first floating island electrode FEL is provided in the region between the first end surface LS1 and the intermediate electrode layer 33 in the first dielectric region DA1, and also in the region between the second end surface LS2 and the intermediate electrode layer 33 in the second dielectric region DA2, thus allowing for relatively reducing the proportion of the dielectric material in the end surface-side outer layer portion. As a result, the intrinsic stress caused by the difference in shrinkage between the dielectric layer 20 and the internal electrode layer 30 in the length direction L can be reduced.

The first floating island electrode FE1 may not necessarily be provided in both of the first dielectric region DA1 and the second dielectric region DA2, but may be provided in either one of the first dielectric region DA1 or the second dielectric region DA2. The first floating island electrodes FE1 may be alternately provided in the first dielectric region DA1 and the second dielectric region DA2 in a staggered manner in the lamination direction T.

The ratio A/B of the dimension A of the first floating island electrode FE1 in the length direction L to the dimension B between the end surface LS of the multilayer body 10 and the intermediate electrode layer 33 provided on both sides of the first floating island electrode FEL in the length direction L is, for example, preferably between about 0.17 and about 0.37 inclusive. The ratio C/D of the dimension C of the first floating island electrode FE1 in the lamination direction T to the dimension D of the intermediate electrode layer 33, which is provided side by side with the first floating island electrode FE1, in the lamination direction T is, for example, preferably between about 0.4 and about 1.0 inclusive. When the ratio A/B is less than about 0.17, the stress relief by the first floating island electrode FE1 is reduced. Conversely, when the ratio A/B exceeds about 0.37, electric conduction is provided between the intermediate electrode layer 33 and the external electrode 40 through the first island electrode FE1, and short circuiting may occur. When the ratio C/D is less than about 0.4, the stress relief by the first floating island electrode FEL is reduced. Conversely, when the ratio C/D exceeds about 1.0, the difference in shrinkage between the dielectric layer 20 and the internal electrode layer 30 may cause increased interface delamination due to intrinsic stress.

The ratio A/B of the dimension A of the first floating island electrode FE1 in the length direction L to the dimension B between the end surface LS of the multilayer body 10 and the intermediate electrode layer 33 provided on both sides of the first floating island electrode FE1 in the length direction L is, for example, set between about 0.17 and about 0.37 inclusive, and the ratio C/D of the dimension C of the first floating island electrode FE1 in the lamination direction T to the dimension D of the intermediate electrode layer 33, which is provided side by side with the first floating island electrode FE1, in the lamination direction T is, for example, set between about 0.4 and about 1.0 inclusive. This can further reduce the intrinsic stress caused by the difference in shrinkage between the dielectric layer and the internal electrodes in the length direction L where the impact of differential shrinkage is particularly large, thus reducing or preventing delamination between the dielectric layer and the internal electrode.

The multilayer ceramic capacitor 1 includes a second floating island electrode FE2 that does not connect to either the first external electrode 40A or the second external electrode 40B, in the region between the lateral surface WS and the internal electrode layer 30 of the multilayer body 10. Here, the region between the lateral surface WS of the multilayer body 10 and the internal electrode layer 30 refers to a range in which the second floating electrode FE2 is not in contact with either the lateral surface WS of the multilayer body 10 or the internal electrode layer 30. Specifically, the second floating island electrode FE2 is provided in the region between the first lateral surface WS1 and the first internal electrode layer 31, the region between the first lateral surface WS1 and the second internal electrode layer 32, the region between the second lateral surface WS2 and the first internal electrode layer 31, and the region between the second lateral surface WS2 and the second internal electrode layer 32. As such, in the dielectric region including the dielectric layer, the second floating island electrode FE2 is provided between the two lateral surfaces WS and internal electrode layers 30 on opposite sides in the width direction W of the multilayer body 10, thus allowing for relatively decreasing the proportion of the dielectric material in the lateral surface outer layer portion. As a result, the intrinsic stress caused by the difference in shrinkage between the dielectric layer 20 and the internal electrode layer 30 in the width direction W can be reduced. The second floating island electrode FE2 includes a plurality of small scattered electrode pieces (metal pieces), which can also be seen as a discontinuous group of electrodes when one of the LT, WT, and LW cross sections of the multilayer ceramic capacitor 1 is observed using a scanning electron microscope or metallurgical microscope.

The second floating island electrode FE2 may not necessarily be provided in all of the region between the first lateral surface WS1 and the first internal electrode layer 31, the region between the first lateral surface WS1 and the second internal electrode layer 32, the region between the second lateral surface WS2 and the first internal electrode layer 31, and the region between the second lateral surface WS2 and the second internal electrode 32. The second floating island electrode FE2 may be provided in any of the regions between the first or second lateral surface and the first or second internal electrode layer, i.e., the second floating island electrode FE2 may be provided in any of the region between the first lateral surface WS1 and the first internal electrode layer 31, the region between the first lateral surface WS1 and the second internal electrode layer 32, the region between the second lateral surface WS2 and the first internal electrode layer 31, and the region between the second lateral surface WS2 and the second internal electrode layer 32. The second floating island electrode FE2 may be provided in regularly or randomly alternated locations in the lamination direction T of the region between the first lateral surface WS1 and the first internal electrode layer 31, the region between the first lateral surface WS1 and the second internal electrode layer 32, the region between the second lateral surface WS2 and the first internal electrode layer 31, and the region between the second lateral surface WS2 and the second internal electrode layer 32.

As illustrated in FIGS. 1 and 2, the external electrodes 40 include the first external electrode 40A on the first end surface LS1 side of the multilayer body 10, and the second external electrode 40B on the second end surface LS2 side of the multilayer body 10.

The basic configurations of the first external electrode 40A and the second external electrode 40B are the same or substantially the same. The shape of the first external electrode 40A and the second external electrode 40B is generally plane-symmetrical with respect to the WT cross section at the center of the multilayer ceramic capacitor 1 in the length direction L. Therefore, unless necessary to distinguish, the first external electrode 40A and the second external electrode 40B may collectively be referred to as the external electrodes 40.

The first external electrode 40A is provided on the first end surface LS1. The first external electrode 40A is in contact with the first extension portions D1 of the plurality of first internal electrode layers 31 exposed at the first end surface LS1. Consequently, the first external electrode 40A is electrically connected to the plurality of first internal electrode layers 31. The first external electrode 40A may also be provided on a portion of the first main surface TS1, a portion of the second main surface TS2, a portion of the first lateral surface WS1, and a portion of the second lateral surface WS2. In the present example embodiment, the first external electrode 40A extends from the first end surface LS1 to a portion of the first main surface TS1, a portion of the second main surface TS2, a portion of the first lateral surface WS1, and a portion of the second lateral surface WS2.

The second external electrode 40B is provided on the second end surface LS2. The second external electrode 40B is in contact with each of the second extension portions D2 of the plurality of second internal electrode layers 32 exposed at the second end surface LS2. Consequently, the second external electrode 40B is electrically connected to the plurality of second internal electrode layers 32. The second external electrode 40B may be provided on a portion of the first main surface TS1, a portion of the second main surface TS2, a portion of the first lateral surface WS1, and a portion of the second lateral surface WS2. In the present example embodiment, the second external electrode 40B extends from the second end surface LS2 to a portion of the first main surface TS1, a portion of the second main surface TS2, a portion of the first lateral surface WS1, and a portion of the second lateral surface WS2.

As previously described, within the multilayer body 10, the first counter portion EA of the first internal electrode layer 31 faces the first electrode layer-side counter portion ECA of the intermediate electrode layer 33, interposing the dielectric layer 20 therebetween, thus generating the capacitance CAP1 (first capacitor portion CAP1). The second counter portion EB of the second internal electrode layer 32 faces the second electrode layer-side counter portion ECB of the intermediate electrode layer 33, interposing the dielectric layer 20 therebetween, thus generating the capacitance CAP2 (the second capacitor portion CAP2).

The coupling portion E0 serially connects the capacitance CAP1 and the capacitance CAP2. Therefore, capacitor characteristics of the series-connected capacitance are provided between the first external electrode 40A connected to the first internal electrode layer 31 and the second external electrode 40B connected to the second internal electrode layer 32.

As illustrated in FIGS. 2 to 4B, the first external electrode 40A includes a first base electrode layer 50A, and a first plated layer 60A on the first base electrode layer 50A. Similarly, the second external electrode 40B includes a second base electrode layer 50B, and a second plated layer 60B on the second base electrode layer 50B.

The first base electrode layer 50A is provided on the first end surface LS1. The first base electrode layer 50A is connected to the first extension portions D1 of the plurality of first internal electrode layers 31 exposed at the first end surface LS1. In the present example embodiment, the first base electrode layer 50A extends from the first end surface LS1 to a portion of the first main surface TS1, a portion of the second main surface TS2, a portion of the first lateral surface WS1, and a portion of the second lateral surface WS2.

The second base electrode layer 50B is provided on the second end surface LS2. The second base electrode layer 50B is in contact with the second extension portions D2 of the plurality of second internal electrode layers 32 exposed at the second end surface LS2. In the present example embodiment, the second base electrode layer 50B extends from the second end surface LS2 to a portion of the first main surface TS1, a portion of the second main surface TS2, a portion of the first lateral surface WS1, and a portion of the second lateral surface WS2.

The first base electrode layer 50A and the second first base electrode layer 50B include at least one of a fired layer, a thin film layer, etc.

The first base electrode layer 50A and the second base electrode layer 50B of the present example embodiment are, for example, fired layers. The fired layer preferably includes a metal component and either a glass component or a ceramic component, or both. The metal component may include, for example, at least one of Cu, Ni, Ag, Pd, Ag—Pd alloy, or Au. The glass component may include, for example, at least one of B, Si, Ba, Mg, Al, or Li. The ceramic component may use the same ceramic material as the dielectric layer 20 or a different type of ceramic material. Examples of the ceramic component include at least one of CaZro₃ (calcium zirconate), CaTio (calcium titanate), SrTiO₃ (strontium titanate), BaZro₃ (proton-conductive metal oxide), or titanium dioxide (TiO₂), etc.

The fired layer is formed by applying a conductive paste containing glass and metal to the multilayer body 10, followed by firing. The fired layer can be formed by simultaneously firing a pre-firing multilayer chip, which is a material of the multilayer body 10 including the plurality of internal electrode layers and dielectric layers, and the conductive paste applied to the multilayer chip. Alternatively, the fired layer can be formed by obtaining the multilayer body 10 by firing the multilayer chip and then applying the conductive paste to the multilayer body 10, followed by firing. In the case as described above, the fired layer is preferably formed by firing a mixture containing ceramic material instead of a glass component. In this case, as the ceramic material to be added, using a ceramic material the same as or similar to the dielectric layer 20 is particularly preferable. The fired layer may include a plurality of layers.

The thickness of the first base electrode layer 50A provided on the first end surface LS1 in the length direction L is, for example, preferably between about 3 μm and about 200 μm inclusive at the center of the first base electrode layer 50A in the lamination direction T and the width direction W.

The thickness of the second base electrode layer 50B provided on the second end surface LS2 in the length direction L is, for example, preferably between about 3 μm and about 200 μm inclusive at the center of the second base electrode layer 50B in the lamination direction T and the width direction W.

In cases where the first base electrode layer 50A is also provided on a portion of at least one of the first main surface TS1 or the second main surface TS2, the thickness of the first base electrode layer 50A provided in this portion in the lamination direction T is, for example, preferably between about 3 μm and about 25 μm inclusive at the center of the first base electrode layer 50A provided in this portion in the length direction L and the width direction W.

In cases where the first base electrode layer 50A is also provided on a portion of at least one of the first lateral surface WS1 or the second lateral surface WS2, the thickness of the first base electrode layer 50A provided in this portion in the width direction W is, for example, preferably between about 3 μm and about 25 μm inclusive at the center of the first base electrode layer 50A provided in this portion in the length direction L and the lamination direction T.

In cases where the second base electrode layer 50B is also provided on a portion of at least one of the first main surface TS1 or the second main surface TS2, the thickness of the second base electrode layer 50B provided in this portion in the lamination direction T is, for example, preferably between about 3 μm and about 25 μm inclusive at the center of the second base electrode layer 50B provided in this portion in the length direction L and the width direction W.

In cases where the second base electrode layer 50B is also provided on a portion of at least one of the first lateral surface WS1 or the second lateral surface WS2, the thickness of the second base electrode layer 50B provided in this portion in the width direction W is, for example, preferably between about 3 μm and about 25 μm inclusive at the center of the second base electrode layer 50B provided in this portion in the length direction L and the lamination direction T.

In the present example embodiment, the first base electrode layer 50A and the second base electrode layer 50B may be thin film layers. A thin film layer is a layer of accumulated metal particles.

The first base electrode layer 50A and the second base electrode layer 50B, when formed as thin film layers, are preferably formed using a thin film formation method such as, for example, a sputtering or vapor deposition method. Here, sputtering electrodes formed by the sputtering method are described.

The first base electrode layer 50A of the present example embodiment may include a first thin film layer formed of a sputtering electrode, for example. The second base electrode layer 50B may include a second thin film layer formed of a sputtering electrode, for example. When forming the base electrode layer with the sputtering electrode, the sputtering electrode is preferably directly formed on at least a portion of either the first main surface TS1 or the second main surface TS2 of the multilayer body 10. The first thin film layer formed of the sputtering electrode is provided on a portion of the first main surface TS1 on the first lateral surface WS1 side. The second thin film layer formed of the sputtering electrode is provided on a portion of the first main surface TS1 on the second lateral surface WS2 side.

The thin film layer formed of the sputtering electrode preferably includes, for example, at least one of Mg, Al, Ti, W, Cr, Cu, Ni, Ag, Co, Mo, or V. As a result, the strength of fixing the external electrodes 40 to the multilayer body 10 can be improved. The thin film layer may include a single layer or a plurality of layers. For example, the thin film layer may include a two-layer structure including a Ni—Cr alloy layer and a Ni—Cu alloy layer.

The first plated layer 60A is provided to cover the first base electrode layer 50A.

The second plated layer 60B is provided to cover the second base electrode layer 50B.

The first plated layer 60A and the second plated layer 60B may include, for example, at least of Cu, Ni, Sn, Ag, Pd, Ag—Pd alloy, or Au. The first plated layer 60A and the second plated layer 60B may include a plurality of layers. The first plated layer 60A and the second plated layer 60B preferably include, for example, a two-portion structure in which a Sn plated layer is provided on top of a Ni plated layer.

In the present example embodiment, the first plated layer 60A includes, for example, a first Ni plated layer 61A, and a first Sn plated layer 62A on the first Ni plated layer 61A. In the present example embodiment, the second plated layer 60B includes, for example, a second Ni plated layer 61B, and a second Sn plated layer 62B on the second Ni plated layer 61B.

The Ni plated layer prevents the first base electrode layer 50A and the second base electrode layer 50B from being eroded by solder when mounting the multilayer ceramic capacitor 1. The Sn plated layer improves the wettability of solder when mounting the multilayer ceramic capacitor 1. As a result, the multilayer ceramic capacitor 1 can be easily mounted. The thickness of the first Ni plated layer 61A, the first Sn plated layer 62A, the second Ni plated layer 61B, and the second Sn plated layer 62B is, for example, preferably between about 2 μm and about 10 μm inclusive.

The external electrodes 40 of the present example embodiment may include, for example, a conductive resin layer including conductive particles and thermosetting resin. The conductive resin layer may be provided to cover the fired layer. In the case where the conductive resin layer covers the fired layer, the conductive resin layer is provided between the fired layer and the plated layers (the first plated layer 60A, the second plated layer 60B). The conductive resin layer may completely cover the fired layer or partially cover the fired layer.

A conductive resin layer including thermosetting resin is more flexible than a conductive layer made from a plating film or a fired conductive paste. Therefore, the conductive resin layer defines and functions as a cushioning layer, even if the multilayer ceramic capacitor 1 is subjected to physical shock or thermal-cycling shock. Therefore, the conductive resin layer reduces or prevents the occurrence of cracks in the multilayer ceramic capacitor 1.

The metals of the conductive particles may be, for example, Ag, Cu, Ni, Sn, or Bi, or alloys including Ag, Cu, Ni, Sn, or Bi. For example, the conductive particles preferably include Ag (silver). The conductive particles are, for example, metallic powder of Ag. Ag has the lowest specific resistance among metals, thus suitable as an electrode material. Ag being a noble metal is resistant to oxidation and has high weather resistance. Therefore, metallic powder of Ag is suitable as conductive particles.

The conductive particles may be metal powders coated with Ag on the surfaces thereof. When using a metal powder coated with Ag, the metal powder is, for example, preferably Cu, Ni, Sn, Bi, or their alloy powder. Ag-coated metal powders are preferably used in order to maintain the properties of Ag while controlling the cost of base metal.

The conductive particles may be, for example, Cu or Ni subjected to antioxidant treatment. The conductive particles may be, for example, metal powder coated with Sn, Ni, or Cu on the surfaces thereof. When using metal powder coated with Sn, Ni, or Cu, the metal powder is, for example, preferably Ag, Cu, Ni, Sn, Bi, or their alloy powders.

The shape of the conductive particles is not particularly limited. Conductive particles can be of various shapes, including spherical and flat shapes, but it is preferable to use a mixture of spherical metal powders and flat metal powders.

The conductive particles included in the conductive resin layer primarily ensure the conductivity of the conductive resin layer. Specifically, a plurality of conductive particles touching each other provide conductive pathways within the conductive resin layer.

The resin of the conductive resin layer may include at least one of various known thermosetting resins, such as, for example, epoxy resin, phenolic resin, urethane resin, silicone resin, polyimide resin, among others. Among these, epoxy resin, known for its excellent heat resistance, moisture resistance, and adhesiveness, is one of the more suitable resins. The resin of the conductive resin layer preferably includes a curing agent along with the thermosetting resin. When using epoxy resin as the base resin, the curing agent for epoxy resin may be one of various known compounds, such as, for example, phenolic, amine, anhydride, imidazole, active ester, amid-imide series.

The conductive resin layer may include a plurality of layers. The thickest portion of the conductive resin layer is, for example, preferably between about 10 μm and about 150 μm inclusive.

The first plated layer 60A and the second plated layer 60B may be directly provided on the multilayer body 10, instead of providing the first base electrode layer 50A and the second base electrode layer 50B. In other words, the multilayer ceramic capacitor 1 may include plated layers directly electrically connected to the first internal electrode layer 31 and the second internal electrode layer 32. In such cases, a catalyst may be applied to the surface of the multilayer body 10 as a pretreatment, followed by forming the plated layers.

Even in this case, the plated layers preferably include a plurality of layers. The base plated layers and the top plated layers may each include at least one type of metal or alloy selected from, for example, Cu, Ni, Sn, Pb, Au, Ag, Pd, Bi, or Zn. The base plated layer is, for example, more preferably made using Ni, which has solder barrier properties. The top plated layer is, for example, more preferably formed using Sn or Au, known for good solder wettability. For instance, when the first internal electrode layer 31 and the second internal electrode layer 32 are formed using Ni, the base plated layer is preferably formed using Cu, which bonds well with Ni. The top plated layer may be provided as needed, and the external electrodes 40 may solely include the base plated layers. The plated layer may include the top plated layer as the outermost layer, or may further include another plated layer on the surface of the top plated layer.

The thickness of each of the plated layers, when provided without a base electrode layer, is, for example, preferably between about 2 μm and about 10 μm inclusive. The plated layer preferably does not include glass. The metal ratio per unit volume of the plated layer is, for example, preferably about 99 volume& or higher.

Direct formation of the plated layer on the multilayer body 10 can reduce the thickness of the base electrode layer. Thus, reducing the thickness of the base electrode layer results in a reduction in the dimension of the multilayer ceramic capacitor 1 in the lamination direction T, allowing for reducing the height of the multilayer ceramic capacitor 1. Alternatively, the reduction in the thickness of the base electrode layer results in an increase in the thickness of the dielectric layer 20 interposed between the first internal electrode layer 31, the second internal electrode layer 32, and the intermediate electrode layer 33, improving the body thickness. As such, direct formation of the plated layer on the multilayer body 10 improves the design flexibility of the multilayer ceramic capacitor.

The basic configuration of the multilayer ceramic capacitor 1 according to the present example embodiment has been described above. The dimension of the multilayer ceramic capacitor 1 including the multilayer body 10 and the external electrodes 40 in the length direction, referred to as the L dimension, is, for example, preferably between about 0.2 mm and about 10 mm inclusive. The dimension of the multilayer ceramic capacitor 1 in the lamination direction, referred to as the T dimension, is, for example, preferably between about 0.1 mm and about 10 mm inclusive. The dimension of the multilayer ceramic capacitor 1 in the width direction, referred to as the W dimension, is, for example, preferably between about 0.1 mm and about 10 mm inclusive.

### EXAMPLES

### Delamination Test

An ultrasonic flaw detector was used to irradiate the samples with 20 kHz ultrasonic waves, and internal cracks or delamination were detected based on the difference between the incident waves and the reflected waves. The interface delamination occurrence time and the interface full delamination time of the dielectric layer and the internal electrode layer were evaluated using the following method.

The chip was polished to expose the internal electrode layer. The exposed surface of the internal electrode layer was cleaned with a mixed solution primarily composed of ethanol.

The multilayer chip was held with tweezers, which were fixed to a stand. The negative pole of the DC power source was connected to the upper portion of the tweezers. The stand was adjusted so that a portion of the multilayer chip held by the tweezers was immersed in a sodium hydroxide solution contained in a petri dish.

One end of a Pt wire connected to the positive pole of the DC power source was immersed in the sodium hydroxide solution in the petri dish.

A voltage of about 5 V from the DC power source was applied, and the presence or absence of crack formation was checked every minute using the ultrasonic flaw detector.

The time from the start of the 5 V voltage application to the first confirmation of interface delamination was recorded as the interface delamination occurrence time. The time from the start of the 5 V voltage application until confirming the entire interface delamination was recorded as the interface full delamination time.

### Samples

$$Size of the multilayer ceramic capacitor : about 3.4 mm ( L ) \times about 2.7 mm ( W ) \times about 2.7 mm ( T )$$

Rated voltage: about 1000 V
Dielectric layer: CaZro₃ (thickness of the dielectric layer: about 3.96 μm)
Internal electrode layer: Ni (thickness of the intermediate electrode layer: about 0.82 μm (target), dimension of the end surface-side outer layer portion in the length direction L: about 200 μm (target))
First floating island electrode: Present (Example), Absent (Comparative Example)
Second floating island electrode: Present (Example), Absent (Comparative Example)

### Structure of the Multilayer Body: Two-Portion Structure Evaluation Criteria for Delamination Test

As for the evaluation criteria for the delamination test, the interface full delamination time of about 40 minutes or more was defined as a pass (◯), about 30 minutes or more and less than about 40 minutes was defined as an acceptable pass (Δ), and less than about 30 minutes was defined as a fail (×).

### Short-Circuit Evaluation Test

For the tests, 100 samples were used, and resistance value was measured after about 1000 V DC current was applied for about 60 seconds.

Samples with a resistance value of about 1000Ω or less were defined as samples in which a short circuit occurred.

### Evaluation Criteria for Short-Circuit Evaluation

In the evaluation criteria for short-circuit evaluation, when the number of samples in which short-circuit occurred among 100 samples was 0, the result was evaluated as “∘” (circle symbol) indicating good, when the number of samples in which short-circuit occurred among 100 samples was from 1 to 5, the result was evaluated as “Δ” (triangle symbol) indicating fair, and when the number of samples in which short-circuit occurred among 100 samples was 6 or more, the result was evaluated as “×” (cross symbol) indicating poor.

### Measurement of Dimensions of the Intermediate Electrode Layer and the First Floating Island Electrode

The dimensions of the intermediate electrode layer 33 and the first floating island electrode FEL can be measured with the following method.

First, the cross section of the multilayer ceramic capacitor 1 was exposed. Specifically, the multilayer ceramic capacitor 1 was polished to the central position in the width direction W.

Then, a scanning electron microscope (SEM) was used to observe the polished cross section under the conditions of an acceleration voltage of 15 kV and a magnification of 2000×, and the dimensions of the electrodes were measured by binarization processing.

TABLE 1

| | Dimension B of | Dimension D of | | | | Dimension C of |
|---|---|---|---|---|---|---|
| | the end surface- | the intermediate | | | Dimension A of | the first floating |
| | side outer layer | electrode layer | Presence or | Presence or | the first floating | island electrode |
| | portion in the | 33 in the | absence of the | absence of the | island electrode | in the direction |
| | direction L | direction T | first floating | second floating | in the direction L | T |
| | (μm) | (μm) | island electrode | island electrode | (μm) | (μm) |
| Comparative | 224 | 0.82 | Absent | Absent | — | — |
| Example 1 | | | | | | |
| Example 1 | 228 | 0.82 | Present | Present | 84 | 0.82 |
| Example 2 | 234 | 0.81 | Present | Present | 67 | 0.62 |
| Example 3 | 225 | 0.79 | Present | Present | 51 | 0.45 |
| Example 4 | 222 | 0.82 | Present | Present | 37 | 0.33 |
| Example 5 | 231 | 0.81 | Present | Present | 53 | 0.21 |
| Example 6 | 228 | 0.78 | Present | Present | 25 | 0.1 |
| Example 7 | 203 | 0.83 | Present | Present | 24 | 0.43 |
| Example 8 | 235 | 0.82 | Present | Present | 98 | 1.53 |
| Example 9 | 229 | 0.85 | Present | Present | 52 | 1.63 |
| Example 10 | 202 | 0.81 | Present | Present | 84 | 0.45 |

| | | | Interface | | | Number of | | |
|---|---|---|---|---|---|---|---|---|
| | | | delamination | Interface full | Evaluation of | occurrence of | | |
| | | | occurrence | delamination | delamination | short circuit | Evaluation of | Comprehensive |
| | A/B | C/D | time(minute) | time(minute) | test | (piece) | short circuit | evaluation |
| Comparative | 0 | 0 | 20 | 22 | x | 0/100 | ∘ | x |
| Example 1 | | | | | | | | |
| Example 1 | 0.37 | 1 | 42 | 45 | ∘ | 0/100 | ∘ | ∘ |
| Example 2 | 0.29 | 0.77 | 40 | 42 | ∘ | 0/100 | ∘ | ∘ |
| Example 3 | 0.23 | 0.57 | 42 | 44 | ∘ | 0/100 | ∘ | ∘ |
| Example 4 | 0.17 | 0.4 | 40 | 42 | ∘ | 0/100 | ∘ | ∘ |
| Example 5 | 0.23 | 0.26 | 34 | 39 | Δ | 0/100 | ∘ | Δ |
| Example 6 | 0.11 | 0.13 | 30 | 32 | Δ | 0/100 | ∘ | Δ |
| Example 7 | 0.12 | 0.52 | 33 | 37 | Δ | 0/100 | ∘ | Δ |
| Example 8 | 0.42 | 1.86 | 30 | 31 | Δ | 1/100 | Δ | Δ |
| Example 9 | 0.23 | 1.92 | 32 | 38 | Δ | 0/100 | ∘ | Δ |
| Example 10 | 0.42 | 0.56 | 42 | 46 | ∘ | 2/100 | Δ | Δ |

It was confirmed that the presence of the floating island electrodes yields favorable results, in which the interface full delamination time falls within the pass or acceptable pass range. Furthermore, as illustrated in Table 1, particularly favorable results were confirmed when the ratio A/B of the dimension A of the first floating island electrode FEL in the length direction L to the dimension B between the end surface LS of the multilayer body 10 and the intermediate electrode layer 33 provided on both sides of the first floating island electrode FE1 in the length direction L is between about 0.17 and about 0.37 inclusive, and the ratio C/D of the dimension C of the first floating island electrode FE1 in the lamination direction T to the dimension D of the intermediate electrode layer 33, which is provided side by side with the first floating island electrode FE1, in the lamination direction T is between about 0.4 and 1.0 inclusive.

### Manufacturing Method

Next, an example of a method of manufacturing the multilayer ceramic capacitor 1 of the present example embodiment is described. The method of manufacturing the multilayer ceramic capacitor 1 of the present example embodiment is not limited, as long as the requirements mentioned above are satisfied. However, an example of a preferable manufacturing method includes the following steps. The steps are described in detail below. A dielectric sheet for the dielectric layer 20 and a conductive paste for the internal electrode layer 30 are prepared. The dielectric sheet, and the conductive paste for the internal electrode layer include binders and solvents. The binders and solvents may be any known ones.

A conductive paste for forming the first internal electrode layer 31 and the second internal electrode layer 32 is printed in a predetermined pattern on the dielectric sheet, for example, by screen printing or gravure printing. A conductive paste for forming the second floating island electrode FE2 is printed. As a result, the layout pattern of the internal electrode layer 30 and the second floating island electrode FE2 as illustrated in FIG. 4A continues in the length direction L and the width direction W, on the dielectric sheet thus prepared. The conductive paste for forming the second floating island electrode FE2 may be printed before or simultaneously with printing the conductive paste for forming the first internal electrode layer 31 and the second internal electrode layer 32.

A conductive paste for forming the intermediate electrode layer 33 is printed in a predetermined pattern on the dielectric sheet, for example, by screen printing or gravure printing. A conductive paste for forming the first floating island electrode FEL is printed. As a result, the layout pattern of the intermediate electrode layer 33 and the first floating island electrode FE1 as illustrated in FIG. 4B continues in the length direction L and the width direction W, on the dielectric sheet thus prepared. The conductive paste for forming the first floating island electrode FE1 may be printed before or simultaneously with printing the conductive paste for forming the intermediate electrode layer 33. The conductive paste for the floating island electrodes can be printed by screen printing with a discrete pattern mesh.

The dielectric sheets printed with the conductive paste for forming the first internal electrode layer 31, the second internal electrode layer 32, and the second floating island electrode FE2 are alternately stacked with the dielectric sheets printed with the conductive paste for forming the intermediate electrode layer 33 and the first floating island electrode FE1. A predetermined number of dielectric sheets without printed conductive paste are stacked to interpose the alternately stacked multilayer sheets. The dielectric sheets without printed conductive paste form the first main surface-side outer layer portion 12 and the second main surface-side outer layer portion 13.

The multilayer sheet is pressed in the height direction, for example, by hydrostatic pressure pressing, to produce a multilayer block.

The multilayer block is cut into multilayer chips of a predetermined size. In this case, the multilayer chips may be polished, for example, by barrel polishing, to round the corners and edges.

The multilayer chips are fired to produce the multilayer body 10. The firing temperature is about, preferably between about 900° C. and about 1400° C. inclusive, depending on the materials of the dielectric layer 20 and the internal electrode layer 30.

A conductive paste, which will form the base electrode layers, is applied to both end surfaces of the multilayer body 10.

In the present example embodiment, the base electrode layer is a fired layer. The conductive paste including glass components and metal is applied to the multilayer body 10, for example, by dipping. Subsequently, the base electrode layer is formed through a firing process. The firing temperature in this case is about, preferably between about 700° C. and about 900° C. inclusive.

In the cases of simultaneously firing the pre-firing multilayer chip and the conductive paste applied to the multilayer chips, the fired layer is about, preferably formed by firing a material including a ceramic material instead of glass components. In this case, as the ceramic material to be added, a ceramic material of the same type as the dielectric layer 20 is preferably used. In this case, a conductive paste is applied to the pre-firing multilayer chips, and the multilayer chips as well as the conductive paste applied the to multilayer chips are simultaneously fired, thus forming the multilayer body 10 with the fired layers.

Subsequently, a plated layer is formed on the surface of the base electrode layers. In the present example embodiment, the first plated layer 60A is formed on the surface of the first base electrode layer 50A. The second plated layer 60B is formed on the surface of the second base electrode layer 50B. In the present example embodiment, a Ni plated layer and a Sn plated layer are formed as the plated layers. For the plating process, for example, either electrolytic plating or electroless plating may be used.

However, electroless plating requires pretreatment with catalysts to improve the plating deposition rate, involving a drawback to increase complexity of the steps. Therefore, electrolytic plating is preferred in most cases. The Ni plated layer and the Sn plated layer are sequentially formed, for example, by barrel plating.

The conductive resin layer, when provided as the base electrode layer, may be provided to cover the fired layer. In the case of providing a conductive resin layer, a conductive resin paste including thermosetting resin and metal components is applied onto the fired layer, followed by heat treatment at temperature ranging from about 250° C. to about 550° C. or higher, for example. This process causes the thermosetting resin to cure, thus forming the conductive resin layer. The atmosphere during this heat treatment is, for example, preferably an N₂ environment. The oxygen concentration is, for example, preferably about 100 ppm or lower in order to prevent the resin from dispersing and prevent the various metal components from oxidating.

The multilayer ceramic capacitor 1 is manufactured through such manufacturing processes.

The present invention is not limited to the two-portion-structured multilayer ceramic capacitors 1 according to the first example embodiment, and can be widely applied to multilayer ceramic capacitors with a series structure.

### Second Example Embodiment

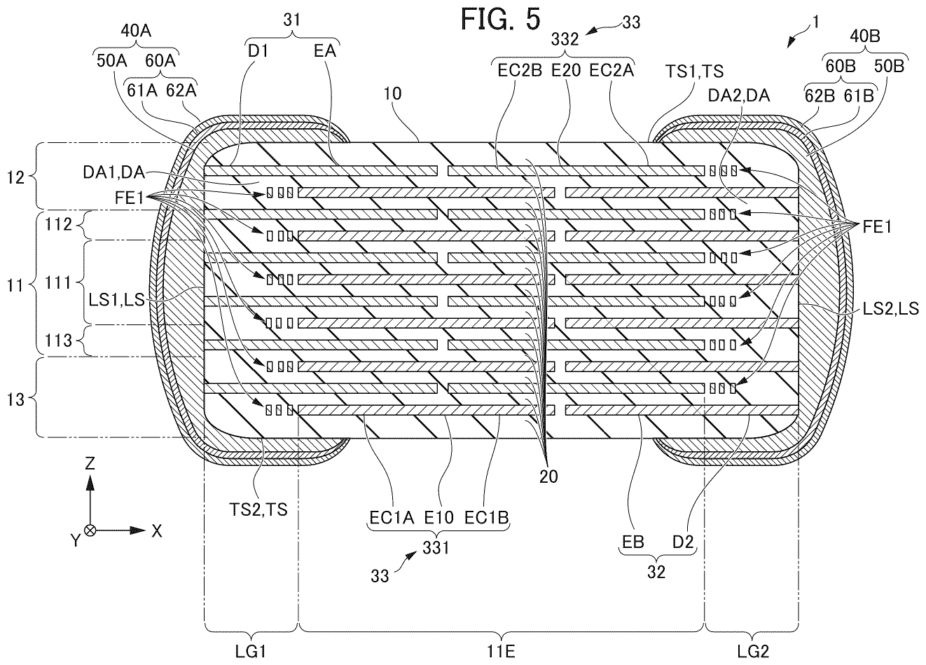

A multilayer ceramic capacitor 1 according to a second example embodiment of the present invention is a three-portion-structured multilayer ceramic capacitor. The following describes the multilayer ceramic capacitor 1 of the second example embodiment with reference to FIG. 5. Detailed description of components the same or substantially the same as those of the first example embodiment may be omitted below. FIG. 5 is a diagram illustrating a schematic configuration of a three-portion-structured multilayer body according to the second example embodiment, corresponding to FIG. 2 of the first example embodiment. The manufacturing method in the second example embodiment is the same as or similar to that in the first example embodiment, description of which is omitted here.

The plurality of internal electrode layers 30 include the plurality of first internal electrode layers 31 as the plurality of first inner conductive layers, the plurality of second internal electrode layers 32 as the plurality of second inner conductive layers, and the intermediate electrode layer 33.

As illustrated in FIG. 5, the intermediate electrode layer 33 of the second example embodiment includes a first intermediate electrode layer 331 and a second intermediate electrode layer 332.

The first intermediate electrode layer 331 includes a first electrode layer-side counter portion EC1A, a first intermediate electrode layer counter portion EC1B, and a first coupling portion E10. The first electrode layer-side counter portion EC1A is a region facing the first internal electrode layer 31 adjacent in the lamination direction T, provided inside the multilayer body 10. The first intermediate electrode layer counter portion EC1B is a region facing the second intermediate electrode layer 332 adjacent in the lamination direction T, provided inside the multilayer body 10. The first coupling portion E10 is a portion connecting the first electrode layer-side counter portion EC1A with the first intermediate electrode layer counter portion EC1B, and is provided between the first electrode layer-side counter portion EC1A and the first intermediate electrode layer counter portion EC1B.

The second intermediate electrode layer 332 includes a second electrode layer-side counter portion EC2A, a second intermediate electrode layer counter portion EC2B, and a second coupling portion E20. The second electrode layer-side counter portion EC2A faces the second internal electrode layer 32 adjacent in the lamination direction T. The second intermediate electrode layer counter portion EC2B faces the first intermediate electrode layer 331 adjacent in the lamination direction T. The second coupling portion E20 is a portion connecting the second electrode layer-side counter portion EC2A with the second intermediate electrode layer counter portion EC2B, and is provided between the second electrode layer-side counter portion EC2A and the second intermediate electrode layer counter portion EC2B.

As illustrated in FIG. 5, in the multilayer ceramic capacitor 1 according to the second example embodiment, the first internal electrode layer 31 and the second intermediate electrode layer 332 are provided adjacent to each other in the length direction L. In the multilayer ceramic capacitor 1 of the second example embodiment, the second internal electrode layer 32 and the first intermediate electrode layer 331 are provided adjacent to each other in the length direction L.

In the multilayer ceramic capacitor 1 of the second example embodiment, the first internal electrode layer 31 and the second intermediate electrode layer 332 are stacked alternately to overlap the second internal electrode layer 32 and the first intermediate electrode layer 331, interposing the dielectric layers 20 therebetween.

In the present example embodiment, the first counter portion EA and the first electrode layer-side counter portion EC1A face each other, interposing the dielectric layer 20 therebetween, thus generating the capacitance CAP1 (first capacitor portion CAP1). The second counter portion EB and the second electrode layer-side counter portion EC2A face each other, interposing the dielectric layer therebetween, thus generating the capacitance CAP2 (second capacitor portion CAP2). The first intermediate electrode layer counter portion EC1B and the second intermediate electrode layer counter portion EC2B face each other, interposing the dielectric layer 20 therebetween, thus generating the capacitance CAP3 (third capacitor portion CAP3). The first coupling portion E10 serially connects the capacitance CAP1 and the capacitance CAP3. The second coupling portion E20 serially connects the capacitance CAP2 and the capacitance CAP3. The multilayer ceramic capacitor 1 of the present example embodiment is a three-portion-structured series-structured multilayer ceramic capacitor 1, in which three capacitor portions are serially connected.

The multilayer body 10 includes a series capacitor forming portion 11E. The series capacitor forming portion 11E includes a portion generating the capacitance CAP1, a portion generating the capacitance CAP2, a portion generating the capacitance CAP3, a portion serially connecting the capacitances CAP1 and CAP3, and a portion serially connecting the capacitances CAP2 and CAP3. The series capacitor forming portion 11E is a portion of the inner layer portion 11. In the series capacitor forming portion 11E, the portion generating the capacitance CAP1 (first capacitor portion CAP1), the portion generating the capacitance CAP2 (second capacitor portion CAP2), and the portion generating the capacitance CAP3 (third capacitor portion CAP3) are also referred to as the capacitor active portions.

The series capacitor forming portion 11E of the multilayer body 10 includes a first series connection region and a second series connection region. The first series connection region is a portion between the portion forming the capacitance CAP1 and the portion generating the capacitance CAP3, encompassing the dielectric layer 20 and the first coupling portion E10, which are. The second series connection region is a portion between the portion generating the capacitance CAP2 and the portion generating the capacitance CAP3, encompassing the dielectric layer 20 and the second coupling portion E20. Thus, the first series connection region is a collective portion including a portion of the plurality of dielectric layers 20 overlapping the first coupling portion E10 as viewed from the lamination direction T, and the plurality of first coupling portions E10. The second series connection region is a collective portion including a portion of the plurality of dielectric layers 20 overlapping the second coupling portion E20 as viewed from the lamination direction T, and the plurality of second coupling portions E20.

As illustrated in FIG. 5, the external electrodes 40 include the first external electrode 40A on the first end surface LS1 side of the multilayer body 10, and the second external electrode 40B on the second end surface LS2 side of the multilayer body 10.

The first coupling portion E10 serially connects the capacitance CAP1 and the capacitance CAP3. The second coupling portion E20 serially connects the capacitance CAP2 and the capacitance CAP3. Therefore, capacitor characteristics of the series-connected capacitance are generated between the first external electrode 40A connected to the first internal electrode layer 31 and the second external electrode 40B connected to the second internal electrode layer 32.

The multilayer ceramic capacitor 1 includes the first floating island electrode FE1 in the region between the end surface LS and the intermediate electrode layer 33 of the multilayer body 10, in the dielectric region DA defined by the dielectric layer 20 interposed between the first internal electrode layers 31 or the second internal electrode layers 32 in the lamination direction T. Here, the region between the end surface LS of the multilayer body 10 and the intermediate electrode layer 33 refers to a range in which the first floating electrode FEL is not in contact with either the end surface LS of the multilayer body 10 or the intermediate electrode layer 33. The multilayer ceramic capacitor 1 includes the first floating island electrode FE1 that does not connect to either the first external electrode 40A or the second external electrode 40B, in the region between the first end surfaces LS1 and the intermediate electrode layer 33, in the first dielectric region DA1 formed with the dielectric layer 20 interposed between the first internal electrode layers 31 in the lamination direction T inside the first end surface-side outer layer portion LG1, also in the region between the second end surfaces LS2 and the intermediate electrode layer 33, in the second dielectric region DA2 formed with the dielectric layer 20 interposed between the second internal electrode layers 32 in the lamination direction T inside the second end surface-side outer layer portion LG2.

The first floating island electrode FEL is provided in the region between the first end surface LS1 and the intermediate electrode layer 33 in the first dielectric region DA1, and also in the region between the second end surface LS2 and the intermediate electrode layer 33 in the second dielectric region DA2, thus allowing for relatively reducing the proportion of the dielectric material in the end surface-side outer layer portion. As a result, the intrinsic stress caused by the difference in shrinkage between the dielectric layer 20 and the internal electrode layer 30 in the length direction L can be reduced.

The first floating island electrode FE1 may not necessarily be provided in both of the first dielectric region DA1 and the second dielectric region DA2, and may be provided in either one of the first dielectric region DA1 or the second dielectric region DA2. The first floating island electrodes FE1 may be alternately provided in the first dielectric region DA1 and the second dielectric region DA2 in a staggered manner in the lamination direction T.

The multilayer ceramic capacitor 1 includes the second floating island electrode FE2 that does not connect to either the first external electrode 40A or the second external electrode 40B, in the region between the lateral surface WS and the internal electrode layer 30 of the multilayer body 10. Here, the region between the lateral surface WS of the multilayer body 10 and the internal electrode layer 30 refers to a range in which the second floating electrode FE2 is not in contact with either the lateral surface WS of the multilayer body 10 or the internal electrode layer 30. Specifically, the second floating island electrode FE2 is provided in the region between the first lateral surface WS1 and the first internal electrode layer 31, the region between the first lateral surface WS1 and the second internal electrode layer 32, the region between the second lateral surface WS2 and the first internal electrode layer 31, and the region between the second lateral surface WS2 and the second internal electrode layer 32. As such, in the dielectric region including the dielectric layer, the second floating island electrode FE2 is provided in the regions between the two lateral surfaces WS and internal electrode layers 30 on opposite sides in the width direction W of the multilayer body 10, thus allowing for relatively decreasing the proportion of the dielectric material in the lateral surface outer layer portion. As a result, the intrinsic stress caused by the difference in shrinkage between the dielectric layer 20 and the internal electrode layer 30 in the width direction W can be reduced.

The second floating island electrode FE2 may be provided in any of the regions between the first or second lateral surfaces and the first or second internal electrode layers, i.e., the second floating island electrode FE2 may not necessarily be provided in all of but any of the region between the first lateral surface WS1 and the first internal electrode layer 31, the region between the first lateral surface WS1 and the second internal electrode layer 32, the region between the second lateral surface WS2 and the first internal electrode layer 31, and the region between the second lateral surface WS2 and the second internal electrode layer 32. The second floating island electrode FE2 may be provided in regularly or randomly alternated locations in the lamination direction T of the region between the first lateral surface WS1 and the first internal electrode layer 31, the region between the first lateral surface WS1 and the second internal electrode layer 32, the region between the second lateral surface WS2 and the first internal electrode layer 31, and the region between the second lateral surface WS2 and the second internal electrode layer 32.

### Third Example Embodiment

The multilayer ceramic capacitor 1 is not limited to the configurations illustrated in FIGS. 1 to 4B. For example, a multilayer ceramic capacitor 1 according to a third example embodiment of the present invention may also be a four-portion-structured multilayer ceramic capacitor as illustrated in FIG. 6.

The following describes the multilayer ceramic capacitor 1 according to the third example embodiment with reference to FIG. 6. Detailed description of components the same or substantially the same as those of the first and second example embodiments are omitted below. The method of manufacturing the multilayer ceramic capacitor of the third example embodiment is the same as or similar to the method of manufacturing the multilayer ceramic capacitor of the first example embodiment, description of which is omitted.

In the multilayer ceramic capacitor 1 of the present example embodiment, the aspect of the internal electrode layers 30 and the external electrodes 40 inside the multilayer body 10 differs from that of the first example embodiment. Specifically, while the multilayer ceramic capacitor 1 of the first example embodiment includes the two-portion structure of the internal electrode layers 30, the multilayer ceramic capacitor 1 of the third example embodiment includes a four-portion structure of the internal electrode layers 30, and the aspect of the internal electrode layers 30 inside the multilayer body 10 differs from that of the first example embodiment.

The plurality of internal electrode layers 30 include the plurality of first internal electrode layers 31 as the plurality of first inner conductive layers, the plurality of second internal electrode layers 32 as the plurality of second inner conductive layers, and the intermediate electrode layer 33.

As illustrated in FIG. 6, the intermediate electrode layer 33 includes a first intermediate electrode layer 331, a second intermediate electrode layer 332, and a third intermediate electrode layer 333.

The first intermediate electrode layer 331 includes the first electrode layer-side counter portion EC1A facing the first internal electrode layer 31 adjacent thereto in the lamination direction T, the first intermediate electrode layer counter portion EC1B facing the third intermediate electrode layer 333 adjacent thereto in the lamination direction T, and the first coupling portion E10.

The second intermediate electrode layer 332 includes the second electrode layer-side counter portion EC2A facing the second internal electrode layer 32 adjacent thereto in the lamination direction T, the second intermediate electrode layer counter portion EC2B facing the third intermediate electrode layer 333 adjacent thereto in the lamination direction T, and the second coupling portion E20.

The third intermediate electrode layer 333 includes the third intermediate electrode layer counter portion EC3A facing the first intermediate electrode layer 331 adjacent thereto in the lamination direction T, the fourth intermediate electrode layer counter portion EC3B facing the second intermediate electrode layer 332 adjacent thereto in the lamination direction T, and the third coupling portion E30.

As illustrated in FIG. 6, in the multilayer ceramic capacitor 1 according to the third example embodiment, the first internal electrode layer 31, the third intermediate electrode layer 333, and the second internal electrode layer 32 are provided adjacent to each other in the length direction L. In the multilayer ceramic capacitor 1 according to the third example embodiment, the first intermediate electrode layer 331 and the second intermediate electrode layer 332 are provided adjacent to each other in the length direction L.

In the multilayer ceramic capacitor 1 according to the third example embodiment, the first internal electrode layer 31, the third intermediate electrode layer 333, and the second internal electrode layer 32 are stacked alternately to overlap the first intermediate electrode layer 331 and the second intermediate electrode layer 332, interposing the dielectric layers 20 therebetween.

In the present example embodiment, the first counter portion EA and the first electrode layer-side counter portion EC1A face each other, interposing the dielectric layer 20 therebetween, thus generating the capacitance CAP1 (first capacitor portion CAP1). The second counter portion EB and the second electrode layer-side counter portion EC2A face each other, interposing the dielectric layer 20 therebetween, thus generating the capacitance CAP2 (second capacitor portion CAP2). The first intermediate electrode layer counter portion EC1B and the third intermediate electrode layer counter portion EC3A face each other, interposing the dielectric layer 20 therebetween, thus generating the capacitance CAP3 (third capacitor portion CAP3). The second intermediate electrode layer counter portion EC2B and the fourth intermediate electrode layer counter portion EC3B face each other, interposing the dielectric layer 20 therebetween, thus generating the capacitance CAP4 (fourth capacitor portion CAP4).

The first coupling portion E10 serially connects the capacitance CAP1 and the capacitance CAP3. The second coupling portion E20 serially connects the capacitance CAP2 and the capacitance CAP4. The third coupling portion the E30 serially connects capacitance CAP3 and the capacitance CAP4. The multilayer ceramic capacitor 1 of the present example embodiment is a four-portion-structured series-structured multilayer ceramic capacitor 1, in which four capacitor portions are serially connected.

The multilayer body 10 includes the series capacitor forming portion 11E. The series capacitor forming portion 11E includes the portion generating the capacitance CAP1, the portion generating the capacitance CAP2, the portion generating the capacitance CAP3, the portion generating the capacitance CAP4, the portion serially connecting the capacitances CAP1 and CAP3, and the portion serially connecting the capacitances CAP2 and CAP4, and the portion serially connecting the capacitances CAP3 and CAP4. The series capacitor forming portion 11E is a portion of the inner layer portion 11. In the series capacitor forming portion 11E, the portion generating the capacitance CAP1 (first capacitor portion CAP1), the portion generating the capacitance CAP2 (second capacitor portion CAP2), the portion generating the capacitance CAP3 (third capacitor portion CAP3), and the portion generating the capacitance CAP4 (fourth capacitor portion CAP4) are also referred to as the capacitor active portions.

The series capacitor forming portion 11E of the multilayer body 10 includes a first series connection region, a second series connection region, and a third series connection region. The first series connection region is a portion between the portion generating the capacitance CAP1 and the portion generating the capacitance CAP3, encompassing the dielectric layer 20 and the first coupling portion E10. The second series connection region is a portion between the portion generating the capacitance CAP2 and the portion generating the capacitance CAP4, encompassing the dielectric layer 20 and the second coupling portion E20. The third series connection region is a portion between the portion generating the capacitance CAP3 and the portion generating the capacitance CAP4, encompassing the dielectric layer 20 and the third coupling portion E30. Thus, the first series connection region is a collective portion including the plurality of dielectric layers 20 overlapping the first coupling portion E10 as viewed from the lamination direction T, and the plurality of first coupling portions E10. The second series connection region is a collective portion including the plurality of dielectric layers 20 overlapping the second coupling portion E20 as viewed from the lamination direction T, and the plurality of second coupling portions E20. The third series connection region is a collective portion including the plurality of dielectric layers 20 overlapping the third coupling portion E30 as viewed from the lamination direction T, and the plurality of third coupling portions E30.

As illustrated in FIG. 6, the external electrodes 40 include the first external electrode 40A on the first end surface LS1 side of the multilayer body 10, and the second external electrode 40B on the second end surface LS2 side of the multilayer body 10.

The first coupling portion E10 serially connects the capacitance CAP1 and the capacitance CAP3. The second coupling portion E20 serially connects the capacitance CAP2 and the capacitance CAP4. The third coupling portion E30 serially connects the capacitance CAP3 and the capacitance CAP4. Therefore, capacitor characteristics of the series-connected capacitance are generated between the first external electrode 40A connected to the first internal electrode layer 31 and the second external electrode 40B connected to the second internal electrode layer 32.

As such, in the multilayer ceramic capacitor 1 of the present example embodiment, the aspect of the internal electrode layers 30 inside the multilayer body 10 differs from that of the first example embodiment. Specifically, while the multilayer ceramic capacitor 1 of the first example embodiment includes the two-portion structure of the internal electrode layers 30, the multilayer ceramic capacitor 1 of the third example embodiment includes a four-portion structure of the internal electrode layers 30, and the aspect of the internal electrode layers 30 inside the multilayer body 10 differs from that of the first example embodiment.

The multilayer ceramic capacitor 1 includes the first floating island electrode FE1 in the region between the end surface LS and the intermediate electrode layer 33 of the multilayer body 10, in the dielectric region DA including the dielectric layer 20 interposed between the first internal electrode layers 31 or the second internal electrode layers 32 in the lamination direction T. Here, the region between the end surface LS of the multilayer body 10 and the intermediate electrode layer 33 refers to a range in which the first floating electrode FEL is not in contact with either the end surface LS of the multilayer body 10 or the intermediate electrode layer 33. The multilayer ceramic capacitor 1 includes the first floating island electrode FE1 that does not connect to either the first external electrode 40A or the second external electrode 40B, in the region between the first end surfaces LS1 and the intermediate electrode layer 33, in the first dielectric region DA1 including the dielectric layer 20 interposed between the first internal electrode layers 31 in the lamination direction T inside the first end surface-side outer layer portion LG1, also in the region between the second end surfaces LS2 and the intermediate electrode layer 33, in the second dielectric region DA2 including the dielectric layer 20 interposed between the second internal electrode layers 32 in the lamination direction T inside the second end surface-side outer layer portion LG2.

The first floating island electrode FEL is provided in the region between the first end surface LS1 and the intermediate electrode layer 33 in the first dielectric region DA1, and also in the region between the second end surface LS2 and the intermediate electrode layer 33 in the second dielectric region DA2, thus allowing for relatively reducing the proportion of the dielectric material in the end surface-side outer layer portion. As a result, intrinsic stress caused by the difference in shrinkage between the dielectric layer 20 and the internal electrode layer 30 in the length direction L can be reduced.

The first floating island electrode FE1 may not necessarily be provided in both of the first dielectric region DA1 and the second dielectric region DA2, and may be provided in either one of the first dielectric region DA1 or the second dielectric region DA2. The first floating island electrodes FE1 may be alternately provided in the first dielectric region DA1 and the second dielectric region DA2 in a staggered manner in the lamination direction T.

The multilayer ceramic capacitor 1 includes the second floating island electrode FE2 that does not connect to either the first external electrode 40A or the second external electrode 40B, in the region between the lateral surface WS and the internal electrode layer 30 of the multilayer body 10. Here, the region between the lateral surface WS of the multilayer body 10 and the internal electrode layer 30 refers to a range in which the second floating electrode FE2 is not in contact with either the lateral surface WS of the multilayer body 10 or the internal electrode layer 30. Specifically, the second floating island electrode FE2 is provided in the region between the first lateral surface WS1 and the first internal electrode layer 31, the region between the first lateral surface WS1 and the second internal electrode layer 32, the region between the second lateral surface WS2 and the first internal electrode layer 31, and the region between the second lateral surface WS2 and the second internal electrode layer 32. As such, in the dielectric region including the dielectric layer, the second floating island electrode FE2 is provided in the regions between the two lateral surfaces WS and internal electrode layers 30 on opposite sides in the width direction W of the multilayer body 10, thus allowing for relatively decreasing the proportion of the dielectric material in the lateral surface outer layer portion. As a result, the intrinsic stress caused by the difference in shrinkage between the dielectric layer 20 and the internal electrode layer 30 in the width direction W can be reduced.

The second floating island electrode FE2 may be provided in any of the regions between the first or second lateral surfaces and the first or second internal electrode layers, i.e., the second floating island electrode FE2 may not necessarily be provided in all of but any of the region between the first lateral surface WS1 and the first internal electrode layer 31, the region between the first lateral surface WS1 and the second internal electrode layer 32, the region between the second lateral surface WS2 and the first internal electrode layer 31, and the region between the second lateral surface WS2 and the second internal electrode layer 32. The second floating island electrode FE2 may be provided in regularly or randomly alternated locations in the lamination direction T of the region between the first lateral surface WS1 and the first internal electrode layer 31, the region between the first lateral surface WS1 and the second internal electrode layer 32, the region between the second lateral surface WS2 and the first internal electrode layer 31, and the region between the second lateral surface WS2 and the second internal electrode layer 32.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body including stacked dielectric layers, and stacked internal electrode layers, two main surfaces on opposite sides in a lamination direction, two lateral surfaces on opposite sides in a width direction orthogonal or substantially orthogonal to the lamination direction, and two end surfaces including a first end surface and a second end surface on opposite sides in a length direction orthogonal or substantially orthogonal to both the lamination direction and the width direction;
a first external electrode on the first end surface; and
a second external electrode on the second end surface; wherein
the internal electrode layers include first internal electrode layers, second internal electrode layers, and an intermediate electrode layer;
the first internal electrode layers include a first extension portion including one end extending to the first end surface and connected to the first external electrode, and a first counter portion connected to the first extension portion and facing an internal electrode layer adjacent thereto in the lamination direction;
the second internal electrode layers include a second extension portion including one end extending to the second end surface and connected to the second external electrode, and a second counter portion connected to the second extension portion and facing an internal electrode layer adjacent in the lamination direction;
the intermediate electrode layer is not connected to either the first external electrode or the second external electrode and defines a serially connected capacitor together with the first internal electrode layers and the second internal electrode layers; and
the multilayer ceramic capacitor further includes:
a first floating island electrode in a region between the first and second end surfaces and the intermediate electrode layer of the multilayer body; and
a second floating island electrode in a region between the lateral surfaces and the internal electrode layers of the multilayer body, in a dielectric region including the dielectric layers interposed between the first internal electrode layers or the second internal electrode layers in the lamination direction.

2. The multilayer ceramic capacitor according to claim 1, wherein
the intermediate electrode layer includes a first electrode layer-side counter portion facing the first internal electrode layer adjacent thereto in the lamination direction, and a second electrode layer-side counter portion facing the second internal electrode layer adjacent thereto in the lamination direction;
the first counter portion of the first internal electrode layer faces the intermediate electrode layer as an internal electrode layer adjacent in the lamination direction; and
the second counter portion of the second internal electrode layer faces the intermediate electrode layer as an internal electrode layer adjacent in the lamination direction.

3. The multilayer ceramic capacitor according to claim 1, wherein
the intermediate electrode layer includes a first intermediate electrode layer and a second intermediate electrode layer;
the first intermediate electrode layer includes a first electrode layer-side counter portion facing the first internal electrode layer adjacent thereto in the lamination direction, and a first intermediate electrode layer counter portion facing the second intermediate electrode layer adjacent thereto in the lamination direction; and
the second intermediate electrode layer includes a second electrode layer-side counter portion facing the second internal electrode layer adjacent thereto in the lamination direction, and a second intermediate electrode layer counter portion facing the first intermediate electrode layer adjacent thereto in the lamination direction.

4. The multilayer ceramic capacitor according to claim 1, wherein
the intermediate electrode layer includes a first intermediate electrode layer, a second intermediate electrode layer, and a third intermediate electrode layer;
the first intermediate electrode layer includes a first electrode layer-side counter portion facing the first internal electrode layer adjacent thereto in the lamination direction, and a first intermediate electrode layer counter portion facing the third intermediate electrode layer adjacent thereto in the lamination direction;
the second intermediate electrode layer includes a second electrode layer-side counter portion facing the second internal electrode layer adjacent thereto in the lamination direction, and a second intermediate electrode layer counter portion facing the third intermediate electrode layer adjacent thereto in the lamination direction; and
the third intermediate electrode layer includes a third intermediate electrode layer counter portion facing the first intermediate electrode layer adjacent thereto in the lamination direction, and a fourth intermediate electrode layer counter portion facing the second intermediate electrode layer adjacent thereto in the lamination direction.

5. The multilayer ceramic capacitor according to claim 2, wherein
a ratio A/B of a dimension A of the first floating island electrode in the length direction to a dimension B between one of the first and second end surfaces of the multilayer body and the intermediate electrode layer provided on both sides of the first floating island electrode in the length direction is between about 0.17 and about 0.37 inclusive; and
a ratio C/D of a dimension C of the first floating island electrode in the lamination direction to a dimension D of the intermediate electrode layer, which is provided side by side with the first floating island electrode, in the lamination direction is between about 0.4 and about 1.0 inclusive.

6. The multilayer ceramic capacitor according to claim 1, wherein
a dimension of the multilayer body in the length direction is between about 0.2 mm and about 10 mm inclusive;
a dimension of the multilayer body in the lamination direction is between about 0.1 mm and about 10 mm inclusive; and
a dimension of the multilayer body in the width direction is between about 0.1 mm and about 10 mm inclusive.

7. The multilayer ceramic capacitor according to claim 1, wherein each of the dielectric layers includes at least one of Ca, Zr, or Ti as a main component.

8. The multilayer ceramic capacitor according to claim 1, wherein each of the dielectric layers includes CaZrO₃ as a main component.

9. The multilayer ceramic capacitor according to claim 8, wherein each of the dielectric layers includes at least one of Mn, Fe, Cr, Co, or Ni compounds as a secondary component.

10. The multilayer ceramic capacitor according to claim 1, wherein a thickness of each of the dielectric layers is about 0.2 μm and about 10 μm inclusive.

11. The multilayer ceramic capacitor according to claim 1, wherein a number of the dielectric layes is between 15 and 1200 inclusive.

12. The multilayer ceramic capacitor according to claim 1, wherein each of the internal electrode layers and the intermediate electrode layer includes at least one of Ni, Cu, Ag, Pd, or Au, or an alloys including at least one of Ni, Cu, Ag, Pd, or Au.

13. The multilayer ceramic capacitor according to claim 1, wherein a thickness of each of the internal electrode layers and the intermediate electrode layer is between about 0.2 μm and about 2.0 μm inclusive.

14. The multilayer ceramic capacitor according to claim 1, wherein each of the first and second external electrodes includes a base electrode layer and a plated layer.

15. The multilayer ceramic capacitor according to claim 14, wherein the base electrode layer is a fired layer including a metal component and at least one of a glass component or a ceramic component.

16. The multilayer ceramic capacitor according to claim 15, wherein the metal component is at least one of Cu, Ni, Ag, Pd, Ag—Pd alloy, or Au.

17. The multilayer ceramic capacitor according to claim 14, wherein a thickness of the base electrode layer is between about 3 μm and about 200 μm inclusive at a center of the base electrode layer in the lamination direction and the width direction.

18. The multilayer ceramic capacitor according to claim 14, wherein the base electrode layer extends to a portion of each of the two main surfaces and the two lateral surfaces.
